(19) United States
(12) Patent Application Publication
(10) Pub. No.: US 2021/0069969 A1
(43) Pub. Date: Mar. 11, 2021

(54) METHOD OF 3D PRINTING METAL PART

(71) Applicant: TE CONNECTIVITY CORPORATION, Berwyn, PA (US)

(72) Inventor: Xiaoming LUO, Hummelstown, PA (US)

(21) Appl. No.: 16/561,129

(22) Filed: Sep. 5, 2019

(51) Int. Cl. B29C 64/165; B33Y 10/00; B33Y 70/00

(52) U.S. Cl. CPC B29C 64/165; B29K 2105/16; B33Y 70/00; B33Y 10/00

(57) ABSTRACT

A composition for use with a direct light processing apparatus and a method of manufacture. The composition includes a photopolymerizable resin of less than 200 mPa·s measured at 25 degrees Celsius. The photopolymerizable resin cures when exposed to a light of a 405 nanometer wavelength or less. The composition also include a photoinitiator and a metallic powder. The metallic powder has a volumetric concentration greater than 50% of the total volume of the composition. The composition has a viscosity of less than 4000 mPa·s.

### FIELD OF THE INVENTION

The present invention is directed to a composition having metallic powder for use in additive manufacturing and a procedure or method for obtaining metallic products from said composition.

### BACKGROUND OF THE INVENTION

The creation of three-dimensional parts in very competitive timeframes by rapid prototyping procedures is known in the art. One such procedure uses stereolithography machines using a photosensitive liquid material which may be cross-linked or polymerized by illumination. Other procedures use powder sintering machines, employing a raw material in the form of a powder, whereby said powder may be locally bonded by infrared laser scanning.

In addition to liquids, powders, filaments or sheets, there is another range of particularly interesting materials for rapid prototyping highly viscous materials which are not deformed by the action of gravity without necessarily being solids, hereinafter referred to as pastes. These pastes are obtained by blending a solid charge in the form of a powder, for example, a mineral, metallic or ceramic powder, into a bonding agent comprising a photosensitive or heat-cured liquid resin, such as an acrylic, or epoxy photopolymerizable resin traditionally used in stereolithography. The term paste covers, in particular, materials with a very high viscosity, greater than 10,000 mPa·s or the so-called “marked threshold” materials. A “threshold” material does not flow (i.e. has zero gradient) as long as the shear limitation applied to it does not exceed a minimum value. A “marked threshold” is considered to be reached when the value of this shear limitation is greater than 20 Newtons per square meter.

For the formation of three-dimensional parts using these pastes, a layering process is employed. The paste is spread in thin layers, with each layer being selectively solidified by a device emitting radiation, a laser, for example, combined with galvanometric mirrors, as in stereolithography or powder sintering. Such pastes may be used for the manufacturing of metallic products by performing an additional thermal treatment after the above-mentioned formation stage. This treatment, comparable to that of parts obtained by a metal injection molding (MIM) type process, consists on one hand in eliminating the organic portion of the formed part, that is the polymer part and the potential thermo-degradable additives, hereinafter referred to as “debinding,” then in densifying the debinded part by sintering in order to obtain the desired mechanical properties.

However, current pastes do not allow for obtaining metallic products which present satisfactory properties. In fact, problems of cracking, swelling, bubbles or distortion appear during thermal treatment of parts formed from paste compositions and shrinkage phenomena during sintering have yet to be mastered.

It would be, therefore, beneficial to provide a paste composition, which allows one through a prototyping procedure, to obtain metallic parts, which possess sufficient strength and low strain, with notable properties of the metal that was initially in the form of a powder. It would also be beneficial to provide a procedure for obtaining metallic products from the paste composition according to the invention.

### SUMMARY OF THE INVENTION

An embodiment is directed to a composition for use with a direct light processing apparatus. The composition includes a photopolymerizable resin of less than 200 mPa·s measured at 25 degrees Celsius. The photopolymerizable resin cures when exposed to a light of a 405 nanometer wavelength or less. The composition also includes a photoinitiator and a metallic powder. The metallic powder has a volumetric concentration greater than 50% of the total volume of the composition. The composition has a viscosity of less than 4000 mPa·s.

An embodiment is directed to a method of manufacturing a metal part using direct light processing technology. The method includes; i) mixing a paste composition which includes a resin with a viscosity of less than 200 mPa·s measured at 25 degrees Celsius and a metallic powder, the metallic powder having a volumetric concentration greater than 50% of the total volume of the composition, the composition having a viscosity of less than 4000 mPa·s; ii) applying a 100 micron or less initial layer of the composition to a build plate of a direct light processing apparatus; iii) applying a 405 nanometer wavelength or less light source in a pattern to the layer to cure the layer; iv) moving the build platform downward by amount equal to the thickness of the layer; v) applying a 100 micron or less additional layer of the composition to previous layers; vi) applying the 405 nanometer wavelength or less light source in an additional pattern to the additional layer to cure the additional layer; and vii) repeating steps iv), v) and vi) until the part is complete.

An embodiment is directed to a metallic part made by a direct light processing apparatus. The metallic part is made by: i) applying a 100 micron or less initial layer of a composition to a build plate of a direct light processing apparatus, the composition having a viscosity of less than 4000 mPa·s; ii) applying a 10 nanometer wavelength or less light source in a pattern to the layer to cure the initial layer; iii) moving the build platform downward by amount equal to the thickness of the layer; iv) applying a 100 micron or less additional layer of the composition to previous layers; v) applying the 405 nanometer wavelength or less light source in an additional pattern to the additional layer to cure the additional layer; and vi) repeating steps iii), iv) and v) until the part is complete.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an illustrative embodiment of a part that can be manufactured with the composition and process of the present invention.

FIG. 2 is a perspective view an illustrative embodiment of a direct light processing machine that can be used with the composition and process of the present invention.

FIG. 3 is a block diagram of an illustrative process of the present invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

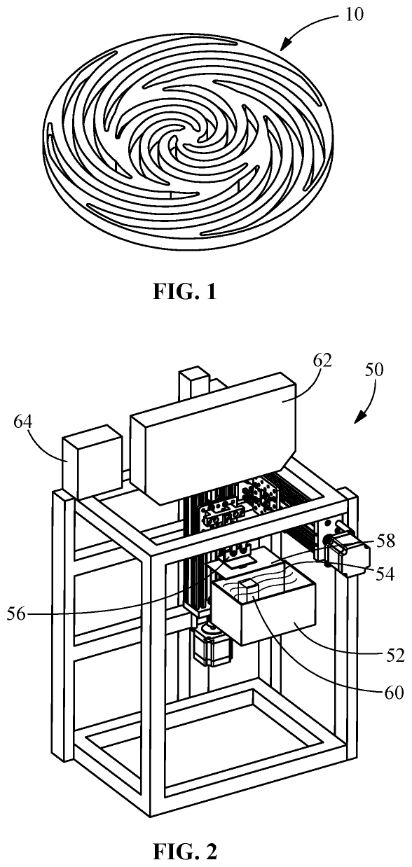

A metallic part 10 (as shown in FIG. 1) is made from a paste composition using an additive 3D printing process, such as direct light processing (DLP) printing technology using a DLP machine 50 (as shown in FIG. 2). The metallic part 10 is shown for illustrative purposes, as the part 10 can be any type of part used in various industries, such as, for example, an electrical connector. The DLP machine 50 is also shown for illustrative purposes, as the machine may have a different configuration without departing from the scope of the invention.

The paste composition according to the invention includes a photopolymerizable or photosensitive resin, in combination with an optional photoinitiator, charged with a metallic powder. The paste composition prepared from this photopolymerizable resin and the metallic powder reacts or cures when exposed to low intensity light, for example, light of a 365 or 405 nanometer wavelength. The paste composition's reactivity is clearly a function of the type of photopolymerizable resin, but also of that of the photoinitiator and the metallic powder used.

The photopolymerizable resin can be an acrylic resin. The photopolymerizable resin used in this invention preferably presents a viscosity of less than 200 mPa·s (at 25 degrees C.). Different acrylate type, photopolymerizable resins activated by low intensity light may be used in this invention, such as polyester It is preferred to reach high metallic powder rates in the photopolymerizable resin (at least 50% by volume but preferably up to 70% if possible) for improved control of the geometry of the sintered parts and accelerated sintering. Therefore, the photopolymerizable resin should have a low viscosity, on the order of 1500 mPa·s, to allow for high powder charge rates to be reached.

In order to reduce the viscosity of the photopolymerizable resin, it is possible to add a specific quantity of a more fluid resin known as a diluent. In various embodiments, the diluent preferably is reactive (that is, it will create a cross-linked network under the influence of the light like the photopolymerizable resin), and may have a viscosity of less than 100 mPa·s. The concentration of the diluent by mass may vary, such as between 2 and 20% by mass with respect to the photopolymerizable resin. This allows for the increase of the volumetric rate of metallic powder.

A metallic powder is part of the paste composition. The volumetric concentration of the metallic powder in the paste composition according to the invention is preferably greater than 50%. Such a volumetric concentration is possible with the use of a photopolymerizable resin as defined above. This high percentage permits a sufficient dimensional control after sintering. The metallic powder preferably includes at least 30% by volume of spherical particles to allow for the increase of the maximum volumetric concentration of metallic powder in the composition and to favor the densification during sintering. The maximum volumetric concentration is the metallic powder concentration for which the composition's viscosity becomes difficult to create homogenous blends by traditional means (blenders) considering the influence of the additive on the formulation.

Preferably, the metallic powder comprises metallic particle sizes in the range of 10 microns to 40 microns. The particle size is based on the thicknesses of the layers used in the digital light processing process or procedure. The metallic particle size is also selected to promote better sintering performance. It is also possible to use powders with smaller particle sizes, for example, a particle size of less than 10 microns, in order to limit the problems of deformation encountered during sintering. In addition, the use of a very-fine metallic powder allows for a better homogenization of the composition and better control of densification.

A homogenous blend of metallic powders, of the same type or otherwise, with smaller particle size and in adequate concentrations may be used in order to significantly increase the maximum volumetric concentration in the metallic powder and improve densification control. Such an increase may be obtained since the finest particles may be positioned in the voids left by the largest particles. For example, in the case of steel particles, the use of a carbonyl iron powder, with a finer particle size than that typical of steel, improves the densification due to the presence of fine particles and limits the deformations due to a higher concentration of steel. In addition, the strength of the metallic product may also be improved thereby. The use of spherical particles may also enhance the maximum volumetric concentration of the paste composition.

One of the conditions which must be met to use the paste composition in a digital light processing rapid prototyping procedure such as the one described in the present invention, is the reactivity of the composition, since it is subjected to low intensity light. The introduction of fillers such as metallic powders strongly diminishes the penetration of light into the composition since part of this radiation is absorbed by the powder and is no longer available for the photopolymerization reaction, thereby limiting the depth of the polymerization so that it is difficult to maintain a layer thickness on the order of 100 microns.

The nature of the metallic powder is not limited to the above examples, and may be made, for example, of carbon steel, tungsten, tungsten carbide, tungsten-cobalt carbide alloy, nickel alloy, chrome alloy, or copper alloy particles, or mixtures thereof. The nature of the metallic powder can easily be determined by one of ordinary skill in the art in view of the final desired product.

Optionally, the paste composition can include a photoinitiator. A photoinitiator is a compound that upon radiation of light decomposes into a reactive species which activates the photopolymerizable resin. Examples of suitable photoinitiators include Diphenyl 2,4,6-Trimethylbenzoyl phosphine oxide. Preferably, less than 1% volume of photoinitiator is added to the paste composition. Determination of such amount would be well within the skill of one of ordinary skill in the art and dependent upon the photopolymerizable resin and metallic powder.

In order to manufacture a part using the composition as described above, an additive 3D printing process, such as direct light processing (DLP) printing technology is used. An illustrative DLP machine 50 is shown in FIG. 2. The DLP machine 50 includes a storage container 52 for housing the metallic paste composition 54 therein. A coating mechanism 56, such as a coating blade, is provided proximate the storage container. The coating mechanism 56 is moveable in a horizontal direction between the storage container 52 and a build plate 58 to move the metallic paste composition 54 from the storage container 52 to the build plate 58. The coating mechanism applies the metallic paste composition 54 in an even and uniform layer. The build plate 58 is movable in a vertical direction to allow additional layers to be deposited thereon by the coating mechanism 56. A mixing device 60 may be included to cooperate with the metallic paste composition 54 to prevent the metallic particles or powder in the metallic paste composition 54 from settling.

A digital light projector 62 is provided proximate the build plate 58. The digital light projector 62 provide light which is projected onto the layer on the build plate 58 to cure the layers. The digital light projector 62 projects low intensity light, for example, light of approximately 365 or 405 nanometer wavelength. The light is projected in individual patterns for each layer provided on the build plate 58 to allow the part to be properly constructed. The individual patterns are communicated to the digital light projector 62 by a controller 64 or similar device.

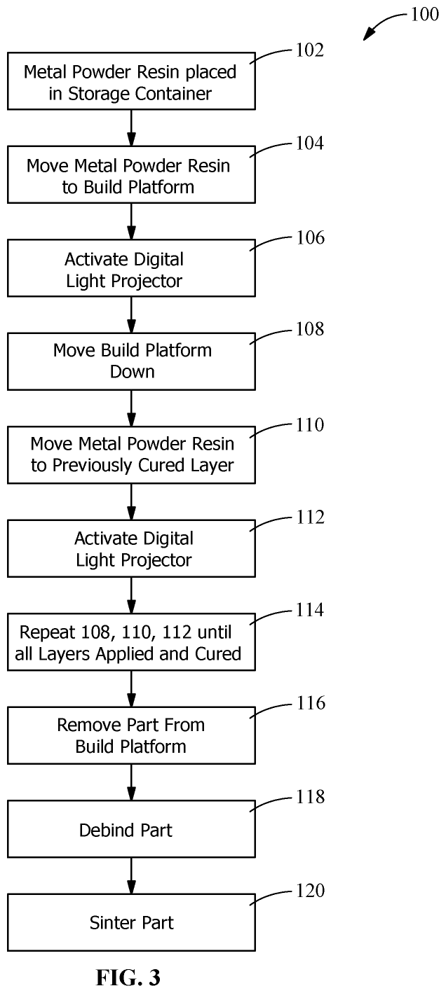

The method of printing the part is illustrated in FIG. 3. Initially, as shown at 100, the desired metal powder is mixed with the low viscosity resin to form the high viscosity metal powder resin. The high viscosity metal powder resin is placed in a storage container which is positioned proximate a build plate of the DLP machine, as represented by 102. The high viscosity metal powder resin is moved from the storage container and is applied in a thin layer to a build platform or the like by a coating blade or the like, as represented by 104. In various illustrative embodiments, the layer may have, for example, a thickness equal to or less than 100 microns, equal to or less than 50 microns (or even thicker), or equal to or less than 25 microns depending on the metallic powder used.

Once the layer is positioned on the build plate, the digital light projector is activated as the light source for curing the layer, as represented by 106. As previously stated, the digital light projector uses low light intensity to cure the resin. The digital light projector applies light in the desired pattern across the layer at the same time to properly cure the resin.

With the initial layer properly cured, the build platform is moved downward by an amount equal to the thickness of the layer, as represented by 108. The high viscosity metal powder resin is moved from the storage container and is applied in a thin layer to the previously cured layer by a coating blade or the like, as represented by 110. In various illustrative embodiments, the layer may have, for example, a thickness equal to or less than 100 microns, equal to or less than 50 microns (or even thicker), or equal to or less than 25 microns depending on the metallic powder used. The digital light projector is again activated as the light source for curing the layer, as represented by 112. As previously stated, the digital light projector uses low light intensity to cure the resin. The digital light projector applies light in the desired pattern for each particular layer across the particular layer at the same time to properly cure the resin. As represented by 114, steps 108, 110 and 112 are repeated until all the layers have been applied and cured.

Depending upon the formulation of the composition and the length of time to produce the part, problems of powder particle sedimentation may occur in the storage container. In fact, powder sedimentation during storage of the paste or during formation leads to a heterogeneity of the composition, primarily in the vertical direction, which over the course of thermal treatment, is translated into differential shrinkage causing distortions or deformations. The storage container may, therefore, include a mixing device to periodically or continuously agitate to mix the composition in the storage container to avoid this issue.

With the layer properly applied and cured, the part may be removed from the build plate, as represented at 116. The part may then be moved to a debinding station, if needed, to remove any excess material or supports from the part, as represented at 118. The debinding treatment of the three-dimensional composite part may be performed by a liquefied neutral or reduction gas system to avoid oxidation.

In order to consolidate the part, the part is subjected to a sintering cycle during which the part undergoes a temperature increase at a determined speed up to a temperature known as the sintering temperature, at which it remains for a specific time (the sintering stage), as represented by 120. The sintering allows for the densification of the parts by suppressing the porosity left by the resin once it has been degraded. This densification is accompanied by a modification of the part's dimensions, known as shrinkage, which is controlled by the sintering temperature and the duration of the stage. This sintering temperature depends on the nature and particle size of the powder and the desired final properties. Mechanical strength is directly related to the density of the finished part. The sintering temperature and the duration of the stage may be adapted as a function of the strength and/or shrinkage limitations during sintering. The sintering temperature is always lower than the melting point of the material. To avoid the oxidation of the metal, the sintering is performed in a neutral atmosphere, for example in argon or nitrogen.

The use of a metallic paste composition with a high metal powder content and high viscosity allows for the final metal part to be manufactured with a high accuracy, high resolution and with a good surface finish, as the shrinkage of the metal part is reduced or minimized.

One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A composition for use with a direct light processing apparatus, the composition comprising:
a photopolymerizable resin of less than 200 mPa·s measured at 25 degrees Celsius, the photopolymerizable resin curing when exposed to a light of a 405 nanometer wavelength or less;
a photoinitiator;
a metallic powder in a volumetric concentration greater than 50% of the total volume of the composition;
the composition having a viscosity of less than 4000 mPa·s.

2. The composition as recited in claim 1, wherein the metallic powder has at least 30% by volume of spherical particles.

3. The composition as recited in claim 1, wherein the metallic powder has particle sizes of less than 40 microns.

4. The composition as recited in claim 1, wherein the metallic powder has particle sizes of between 10 microns and 40 microns.

5. The composition as recited in claim 1, where in metallic powder is chosen from the group consisting essentially of steel, carbon steel, tungsten, tungsten carbide, tungsten cobalt carbide alloy, copper alloy, nickel alloy, chrome alloy or mixtures thereof.

6. The composition as recited in claim 1, wherein said photopolymerizable resin is an acrylic resin.

7. A method of manufacturing a metal part using direct light processing technology, the method comprising;
i) mixing a paste composition which includes a resin with a viscosity of less than 200 mPa·s measured at 25 degrees Celsius and a metallic powder, the metallic powder having a volumetric concentration greater than 50% of the total volume of the composition, the composition having a viscosity of less than 4000 mPa·s;
ii) applying a 100 micron or less initial layer of the composition to a build plate of a direct light processing apparatus;
iii) applying a 405 nanometer wavelength or less light source in a pattern to the layer to cure the layer;
iv) moving the build platform downward by amount equal to the thickness of the layer;
v) applying a 100 micron or less additional layer of the composition to previous layers; and
vi) applying the 405 nanometer wavelength or less light source in an additional pattern to the additional layer to cure the additional layer;
vii) repeating steps iv), v) and vi) until part is complete.

8. The method as recited in claim 7, comprising storing the composition in a storage container which is positioned proximate a build plate of the direct light processing apparatus.

9. The method as recited in claim 8, comprising mixing the composition in the storage tank to avoid sedimentation of the metallic powder.

10. The method as recited in claim 7, wherein the metallic powder has a volumetric concentration greater than 70% of the total volume of the composition.

11. The method as recited in claim 10, comprising applying a 50 micron or less layer of the composition to a build plate of a direct light processing apparatus.

12. The method as recited in claim 10, comprising applying a 25 micron or less layer of the composition to a build plate of a direct light processing apparatus.

13. The method as recited in claim 7, wherein the layers of the composition are applied by a coating blade.

14. The method as recited in claim 7, comprising debinding the completed part to remove excess material.

15. The method as recited in claim 14, comprising debinding the completed part with a liquefied neutral or reduction gas system to avoid oxidation.

16. The method as recited in claim 7, comprising subjecting the completed part to a sintering cycle to allow for the densification of the completed part.

17. A metallic part made by a direct light processing apparatus using a direct light process, said process comprising:
i) applying a 100 micron or less initial layer of a composition to a build plate of a direct light processing apparatus, the composition having a viscosity of less than 4000 mPa·s;
ii) applying a 405 nanometer wavelength or less light source in a pattern to the layer to cure the initial layer;
iii) moving the build platform downward by amount equal to the thickness of the layer;
iv) applying a 100 micron or less additional layer of the composition to previous layers; and
v) applying the 405 nanometer wavelength or less light source in an additional pattern to the additional layer to cure the additional layer;
vi) repeating steps iii), iv) and v) until part is complete.

18. The metallic part as recited in claim 17, wherein the composition comprises:
a photopolymerizable resin of less than 200 mPa·s measured at 25 degrees Celsius, the photopolymerizable resin curing when exposed to a light of a 405 nanometer wavelength or less;
a photoinitiator;
a metallic powder in a volumetric concentration greater than 50% of the total volume of the composition; and
the composition having a viscosity of less than 100 mPa·s.

19. The metallic part as recited in claim 18, wherein the metallic powder has at least 30% by volume of spherical particles.

20. The metallic part as recited in claim 18, wherein the metallic powder has particle sizes of less than 40 microns.
